(19) United States
(12) Patent Application Publication
(10) Pub. No.: US 2015/0229916 A1
(43) Pub. Date: Aug. 13, 2015

(54) METHOD FOR AUTOMATICALLY CORRECTING A VIDEO PROJECTION WITH THE AID OF INVERSE TELECINE

(71) Applicants: Aleksandr Grigorevich Berenok, Kiev (UA); Dmitriy Markovich Giventar, Kiev (UA)

(72) Inventors: Aleksandr Grigorevich Berenok, Kiev (UA); Dmitriy Markovich Giventar, Kiev (UA)

(21) Appl. No.: 14/422,139

(22) PCT Filed: Jul. 5, 2013
(86) PCT No.: PCT/UA2013/000070

§ 371 Date: Feb. 17, 2015

(30) Foreign Application Priority Data
Aug. 17, 2012 (UA) U 2012 09970

(51) Int. Cl. H04N 13/04; G06T 19/00

(52) U.S. Cl. CPC H04N 13/0459; G06T 19/003; H04N 13/0425; G06T 2219/2016

(57) ABSTRACT

A method of automatic correction of video projection by means of inverse transformation by applying of the server, which carries out the delivery of video signals at the engineering device or video screen units, permitting the playback of multidimensional images without their distortion.

### CROSS REFERENCE TO RELATED APPLICATION(S)

This application is a §371 National Stage of PCT Application Serial Number: PCT/UA 2013/000070, filed Jul. 5, 2013, which in turn claims priority to Ukrainian Application Serial Number: 201209970 filed Aug. 17, 2012. The entire disclosure of both the above documents is herein incorporated by reference.

### BACKGROUND

1. Field of the Invention

The invention belongs to the sphere of art, design and composition and can be used for technical provision of presentations, video demonstrations as well as for arrangement of architectural objects.

2. Description of the Related Art

From the level of technique the special equipment is known and namely server, which performs generation of video signal to projecting devices or video screen units.

According to the document JP2009005044(A)—Jan. 8, 2009 the most familiar analog is the method, owned by MITSUBISHI PRECISION CO LTD., which describes the development of correction function of geometric errors by mapping on curved surface. The function is plotted on the basis of the system of point-by-point measurements of errors of mapped test image. Stereo cameras are used for the analysis of errors. Obtained function of the second order is inverted and applied to compiled video image such that the image becomes even relatively observer.

### SUMMARY

There is described here, among other things, a method of automatic correction of video projection, which differs by the fact that it does not have the stages of testing and measurement of geometric errors.

In an embodiment, the method will be applied the visualization of projection in multidimensional space instead of transformation function.

In an embodiment, the method fulfills the correction of characteristics of image pixel by pixel.

In an embodiment of the method, the multidimensional model of the object is put into the server and the projectors are placed and then the object is formed virtually, the scripts are ordered and server carries out the rendering of signals real-time.

In an embodiment of the method, the correct multidimensional modeling of the object and reverse-engineering from the observer are carried out.

In an embodiment of the method there is the possibility of correction of the characteristics of the image, for example luminance, at some reflecting areas.

In an embodiment of the method for, the achievement of the result it is used the precise photometrical calculation of light sources with due consideration of maximum number of impact factors.

There is also described herein a system based on the system LIGHTCONVERSE 3D SHOW PLATFORM, differing by the fact that the virtual lighting fixtures received the possibility to work simultaneously as video cameras and video projectors.

In an embodiment of the system, the library has been extended by standard models of video cameras and video projectors.

In an embodiment, the system has been created the technology of transfer of UV coordinates from screen plane of operator to the surface of multidimensional object.

In an embodiment of the system, the possibility of support of output video signals is increased at least to 15 by opportunity of detachment of each signal to three signals vertically.

In an embodiment of the system, for the virtual cameras all additional functions of standard lighting fixtures will be available.

In an embodiment of the system, each virtual device has precise regulation of boards of projection.

In an embodiment of the system, there is the possibility of its usage for preliminary generation of media content.

### BRIEF DESCRIPTION OF THE DRAWING

FIG. 1 provides an illustration of an example of one projector and screen unit with free form.

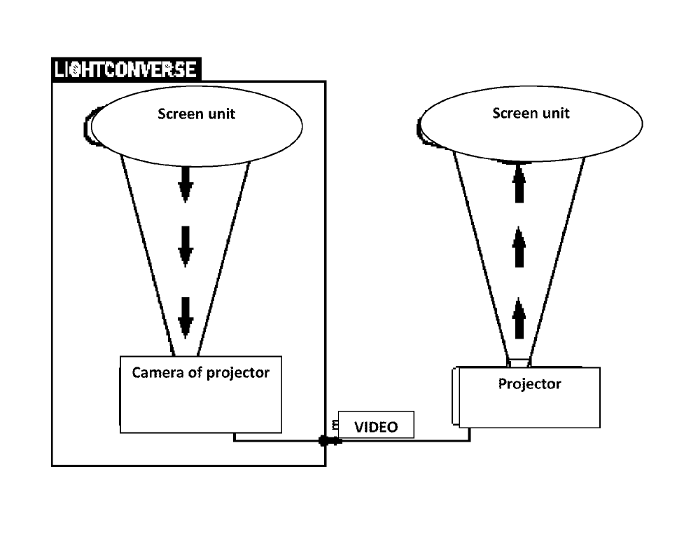

### DETAIL DISCUSSION OF THE PREFERRED EMBODIMENTS

The main difference of this invention is the unavailability of the stage of testing and measurements of geometric errors. In an explicit form the transformation function has been not developed. Instead of this the visualization of mapping in three-dimensional space is applied and inverse transformation will be received automatically by means of simple change of virtual projectors to virtual cameras. Such method allows completing transformations to high precision from any surface not only from the surface of the second order as by analogs. Apart from this the invented device corrects not only geometric errors but also makes pixel by pixel equalization of luminance at shaded areas and areas, directed away from the observer.

Off-the-shelf products, produced at present time, are LIGHTCONVERSE SERVER—STUDIO and LIGHTCONVERSE SERVER—MAPPING. The models are differing with the number of video outputs 6 and 15 correspondingly. They allow performing of three-dimensional correction of 32 video flows, their mixing by means of internal and external management as well as the delivery in form of signals, geared towards mapping device.

At the heart of the invention it is set up the problem of format of object in 3D space from the point of view of observer, placement of virtual cameras at the places of projector's installation and rendering of the object from the point of view of these cameras. Furthermore at the heart of the invention it is set up the problem of creating of the complex of images at different surfaces of complex geometric object and projection of several images at the group of geometric objects at any angle and uniting of several projectors for projection of one complex of images and uniting of several undefined screen shots for projection of one image or complex of images.

Application task is solved by following: proximate three-dimensional model of the object is put into server and the projectors are placed. Then the virtual object is projected, the scripts are ordered. The server makes the rendering of the signals from the point of view of each projector real-time and provides the signals to the physical devices. As a result virtual design is transferred to the meatspace with absolute accuracy and without losses. Created entire system performs indicated transformations real-time.

Now the video screen units and video projectors are widely used for creation of panoramic images. It can be TV studio, theatre, museum exposition, architectural highlighting etc. Panoramic video images unlike static lighting of decorations allow creating of illusion of additional space and solve many production tasks.

The main complexity of the technical support of such projects is non optimal placement of video projectors relatively reflective surfaces or video screen units relatively observer. For example it is not always succeeded to place the projector so that to ensure geometrically even projecting. The standard methods of adjusting of keystone run in only for two-dimensional objects. By projecting, for example, at spherical faceplate the special equalizing lens, which do not solve the problem as a whole, are used. Therefore the projecting at complex integrated geometric objects by means of traditional approach is impossible.

For the receipt of panoramic image the butting of the projectors is applied. In this case it is impossible to place the projectors randomly, because the junction of the boards of mapping will be disrupted.

As a rule in case of video screen units the method “one screen unit—one image” is working. It is practically impossible to receive entire panoramic image relatively observer if the screen units are placed randomly (at different distances and at different angles).

The problem is solved by means of correct 3D modeling of the object and reverse virtual mapping from the observer. In this case all possible geometric errors are compensated automatically, all video projectors and video screen units work automatically with the precision to one pixel and emit the image, for which the viewer waits.

This method allows compensating not only the geometric errors. By its means the luminance can be compensated, leveling of overlapping areas of mapping or conversely brighten in areas of increased lateral reflections. For this the precise photometrical calculating of each light source is used with due regard to reflective characteristics of the object, direction of reflection and place of observer at 3D space.

Thereby desired technical result is achieved by means of offered method; the problem of self-shadowing of complex geometric objects is easily solved. By projecting at one and the same place from two different foreshortenings it is possible to reduce the shadow component twofold, from three foreshortenings—three-fold etc. For example by projecting of image at front of the building with columns the shadow from columns will be removed.

The method is realized on the base of display system LIGHTCONVERSE 3D SHOW PLATFORM. This computer-based system allows creating of virtual three-dimensional presentation of the object and calculates the lighting and its control real-time.

For the problem solution each virtual lighting fixture has received the possibility to work simultaneously as the video camera and video projector. The library of fixtures has been enhanced by standard models of video cameras and video projectors. Generated signals of virtual cameras are sent at physical video outputs of computer and further to real projectors/screen units. Therefore real physical instrument projects such image, which its virtual copy “sees” in virtual world.

LIGHTCONVERSE provides the opportunity to each material of the virtual object to collate static image and texture. For the correct video overlay at three-dimensional object the map of UV coordinates is assigned. This technology is named UV MAPPING. By means of this technology the operator places the image at the surface of the object like necessarily.

For the purpose of facility of creation of UV map it was created the technology of translation of UV coordinates from the screen plane of the operator to the surface of three-dimensional object (Map View). It is necessary to unfold the virtual object such as the viewer sees it and the system will automatically transfer two-dimensional image to three-dimensional space and fix it (Record View). Then basic two-dimensional transformations (dimension, shift, rotating) can be applied to the received map and the images can be replaced with static or video picture. This technology gives the possibility to create easily the illusion of plane by projection at the surface of complex three—dimensional object or by complex spatial location of video screen units.

High quality and speed of visualization of the system LIGHTCONVERSE provide the opportunity to manage visual signals without the loss of resolution (True Resolution). Precise synchronization excludes the effect of mixing of two shots (Tearing). Apart from this adaptive smoothing is additionally carried out for compensation of artifacts, caused by different inclination/rotating of video screen units (Moire).

Illustration of example of one projector and screen unit with free form is represented at the drawing 1/1.

The System LIGHTCONVERSE 3D SHOW PLATFORM with stated license UNLIMITED is the signal source for video projectors/video screen units.

Only three video outputs are conventionally supported. By means of the special equipment and extention of the license to the level UNLIMITED STUDIO EDITION the receipt of 15 video outputs (peak resolution of each three signals together composes 3840*1024 points) is possible. Therewith the possible distribution of each signal to three signals vertically allows, for example, the control of 45 video screen units.

Reproduction of three-dimensional media content within the system LIGHTCONVERSE is carried out in several ways:

1. Reproduction of video files, prepared in advance. External control of luminance, break and coming around to begin are possible. Maximum number of the files loaded simultaneously—32. Resolution and codification are individual.

2. Reception of two-dimensional video signals from media server (Hippotizer, Catalyst etc.) from one or several video inputs. Maximum number of video inputs—9.

3. Direct network connection with media servers Hippotizer. Maximum number of servers—9 with, with two signal each.

It should be noted that although the system LIGHTCONVERSE fulfills some functions of media server (method 1), it is not the same. If there is the problem of synchronized reproduction of several video files and precise transfer between them than it is preferably to use external media server, connected with LIGHTCONVERSE by methods 2 and 3. The main purpose of the system in described variant of usage is a three-dimensional multirendering in a real time and distribution of video streams, but not the generation of content for them.

As far as the output video signals are generated by virtual cameras all additional functions of standard lighting fixtures are available for them: luminance control, color control, adjustment of iris, dynamic gobo stencils. By means of them it is possible to carry out the color correction of the signals and to animate them.

Furthermore each virtual device has precise adjustment of the boards of projection (Frame Shutter) that permits to adjust the scopes of mutual interference individually.

LIGHTCONVERSE 3D SHOW PLATFORM encloses complex package of visualization (light, video, pyrotechnics, mechanic of scene etc.) that is why it is possible to use the system for previous generation of media content. For example, we need to receive the virtual extending of acting space at panoramic screen. For this it is possible to prepare responding video rendering of project with needed foreshortening in advance and to use it as video texture or to install the second system LIGHTCONVERSE and get the video signal of rendering from it in a real time that lets light supervisor do verifying of virtual extending of scene like by means of real lighting fixtures.

1.-14. (canceled)

15. A method of automatic correction of video projection comprising:
providing at least one projector at a location, said projector producing a 3-Dimensional video projection of an object;
placing a virtual camera at said location; and
rendering said object from a point of view of said virtual cameral;
wherein, said rendering does not have the stages of testing and measurement of geometric errors.

16. The method of claim 1 wherein visualization of projection is provided in multidimensional space instead of with a transformation function.

17. The method of claim 1, wherein said method corrects characteristics of said video projection pixel by pixel.

18. The method of claim 1:
wherein, a multidimensional model of said object is put into a server prior to said projector being provided; and
wherein said object is formed virtually, scripts are ordered; and said server carries out the rendering of signals real-time.

19. The method of claim 1 wherein correct multidimensional modeling of said object and reverse-engineering from an observer are carried out.

20. The method of claim 1 further comprising correction of characteristics of the projection.

21. The method of claim 20 wherein said characteristic is luminance at a particular reflecting area.

22. the method according of claim 20 wherein said correction utilizes a precise photometrical calculation of light sources with due consideration of maximum number of impact factors.

23. A system for of automatic correction of video projection comprising:
at least one projector at a location, said projector:
producing a 3-Dimensional video projection of an object; and
acting as a virtual camera at said location; and
wherein, rendering of said object is performed from a point of view of said virtual camera; and
wherein, said rendering does not have the stages of testing and measurement of geometric errors.

24. The system of claim 23 wherein a library has been extended by standard models of video cameras and video projectors.

25. The system of claim 23, wherein said virtual camera has been created by technology of transfer of UV coordinates from screen plane of operator to a surface of said object.

26. The system of claim 23 wherein support of output video signals is increased by at least to 15 by opportunity of detachment of each signal to three signals vertically.

27. The system of claim 23 wherein said virtual camera includes all additional functions of standard lighting fixtures.

28. The system of claim 23 wherein said virtual camera has precise regulation of boards of projection.

29. The system of claim 23 where said system preliminary generates media content.
